(19) United States
(12) Patent Application Publication
(10) Pub. No.: US 2014/0025675 A1
(43) Pub. Date: Jan. 23, 2014

(54) AS-BUILT COMPILER

(71) Applicants: Stephen Pineau, Richmond (CA); Turkay Buyucetin, Vancouver (CA)

(72) Inventors: Stephen Pineau, Richmond (CA); Turkay Buyucetin, Vancouver (CA)

(21) Appl. No.: 13/553,099

(22) Filed: Jul. 19, 2012

(51) Int. Cl. G06F 17/30

(52) U.S. Cl. 707/736; 707/E17.045

(57) ABSTRACT

Diverse drawings, documents, files and notes in different formats describing buildings in their finished and installed state are electronically aggregated into sets of as-built drawings for convenient and rapid future access.

### TECHNICAL FIELD

This application relates to a method and system for compiling as-built drawings, and in particular it relates to the aggregation, linking and storage of as-built drawings, documents, files and information from diverse sources and in different formats such that future access to them is facilitated.

### BACKGROUND

As-built drawings depict a final configuration of a building project, whether physical, functional or both. They indicate any construction or installation deviations and show features of a project as actually built. They are intended to provide a permanent record of the as-built configuration and to serve as a reference for future maintenance, repair, renovation or building modification. As-built drawings may show locations for security systems, wiring, plumbing and other hidden components.

As-built drawings should include all the changes that have been made to the originally proposed construction drawings, including notes, modifications, and any other information that the builders decide should be included. While the original drawings are typically produced using computer-aided design software, as-built drawings usually contain handwritten notes, sketches, and changes.

During the building process a building contractor usually runs across unforeseen conditions that require items to be installed differently than as shown on the plans. For simple changes, the contractor will often simply work the problem out himself and note the changes on his set of building plans. With more significant problems, the architect or owner may provide a sketch, a full drawing or a written instruction. Throughout the project, the owner may also issue formal change requests to the construction documents. The contractor will also include these changes on the as-built drawings as a record of the owner's requests.

On large projects, major contractors and subcontractors may maintain their own set of as-built drawings. This allows the electrician, plumber, drywall contractor, and other professionals to make changes without holding up the job. At the end of the project, the set of as-built drawings are combined into a master set for the owner.

Owners or building managers sometimes misplace the master set or parts of it, and sometimes it doesn't even exist as a compiled set. As years go by and building managers come and go, or as modifications are made without changing the as-built set of drawings, it becomes increasingly difficult to identify and locate the components and systems installed in the building. Further, as the as-built set of drawings is usually in the form of a physical binder, or set of binders, it is difficult to rapidly search for specific items or to do a stock take of installed items without having to do a time-consuming walk round. Even when walking round, many details are extremely difficult to determine, particularly if wires, sensors, pipes, etc. are hidden within the walls. Paper copies may also become degraded or damaged over time and back-up copies are rarely available. Furthermore, when as-built drawings are in paper format and stored in the building to which they relate, it is not convenient to retrieve them quickly when needed for dealing with an emergency.

### SUMMARY OF INVENTION

The present invention is directed to a method and system for compiling and storing sets of as-built drawings, documents, files and information obtained from diverse sources and in different formats. It provides the ability to store physical facility data in a central location and provides a means to rapidly create drawings of the facility's portals (i.e. entry and/or exit points) that can be included with the as-built drawings. The compiled information is uploaded to central servers, ready for immediate retrieval, modification or printing from any web connected location, and to satisfy requirements of contingency planning.

One aspect of the present invention is a system for compiling as-built drawings comprising a terminal and a processor connected to the terminal, the processor configured to: receive via the terminal a definition of at least one facility; receive via the terminal, for each facility, at least one facility file relating to a drawing thereof; receive via the terminal a definition of a portal that is installed in one of said facilities, receive via the terminal an identification of the facility to which the portal relates; store the at least one facility file; store a drawing of the portal; and store a relation between the portal and the facility to which the portal relates.

Another aspect of the present invention is a processor-implemented method for compiling as-built drawings, the method comprising: receiving at a processor via input from a terminal a definition of at least one facility; receiving at the processor via input from the terminal, for each facility, at least one facility file relating to a drawing thereof; receiving at the processor via input from the terminal a definition of a portal; receiving at the processor via input from the terminal an identification of the facility to which the portal relates; storing by the processor in a database the at least one facility file; storing by the processor in the database a drawing of the portal; and storing by the processor in the database a relation between the portal and the identification of the facility to which the portal relates.

A further aspect of the present invention is a processor-implemented method for compiling as-built drawings, the method comprising: receiving at a processor via input from a terminal a definition of at least one facility; receiving at the processor via input from the terminal, for each facility, at least one facility file relating to a drawing thereof; receiving at the processor via input from the terminal a definition of at least one room; receiving at the processor via input from the terminal, for each room, an identification of the facility in which the room is located; storing by the processor in the database, for each room, a relation between the room and the facility in which the room is located; receiving at the processor via input from the terminal a definition of a portal, receiving at the processor via input from the terminal an identification of the room to which the portal relates; storing by the processor in the database the at least one facility file; storing by the processor in the database a drawing of the portal; and storing by the processor in the database a relation between the portal and the room to which the portal relates.

### BRIEF DESCRIPTION OF DRAWINGS

The following drawings illustrate embodiments of the invention, but should not be construed as restricting the scope of the invention in any way.

FIG. 1 is a system for compiling and retrieving as-built drawings and related information.

FIG. 2 is a flowchart of a process for storing relations between portals and facilities.

FIG. 3 is a flowchart of a process for storing relations between portals and rooms within a facility.

FIG. 4 is a flowchart of a process for retrieving portal information

FIG. 5 is a flowchart for selecting one or more portals.

FIG. 6 is a sitemap of a system for relating, storing and accessing portal, room and facility information.

FIG. 7 is a schematic diagram of a screenshot for defining a facility.

FIG. 8 is a schematic diagram of a screenshot that depicts a summary of the detail of a facility.

FIG. 9 is a schematic diagram of a screenshot for creating or identifying a portal drawing.

FIG. 10 is a flowchart for creating a portal drawing.

FIG. 11 is a schematic diagram of a screenshot of a portal drawing and related notes.

FIG. 12 is a schematic diagram of a screenshot showing a summary of a portal drawing.

FIG. 13 is a schematic diagram of a screenshot for defining a room.

FIG. 14 is a schematic diagram of a screenshot showing a summary of detail for a room.

FIG. 15 is a schematic diagram of a screenshot for adding a file.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

As-built drawings refer to a set of one or more drawings, files, notes, images and/or video clips that describe a building in its current, actual, constructed state. As-built drawings are described more fully in the Background.

A portal refers to an entrance or exit such as a barrier gate, swing gate, garage door, single door right swing, single door left swing, double door, swivel door, elevator entrance or exit. A portal may be located between rooms or areas inside a building; it may serve as an entrance or exit to the building; or it may be an entrance or exit of a parking lot.

A facility may be a building or a group of buildings.

A user of the system may be a building owner, a building manager, an employee responsible for building related tasks, a security system installer or any professional or other person with an interest in accessing, compiling, modifying or updating as-built drawings.

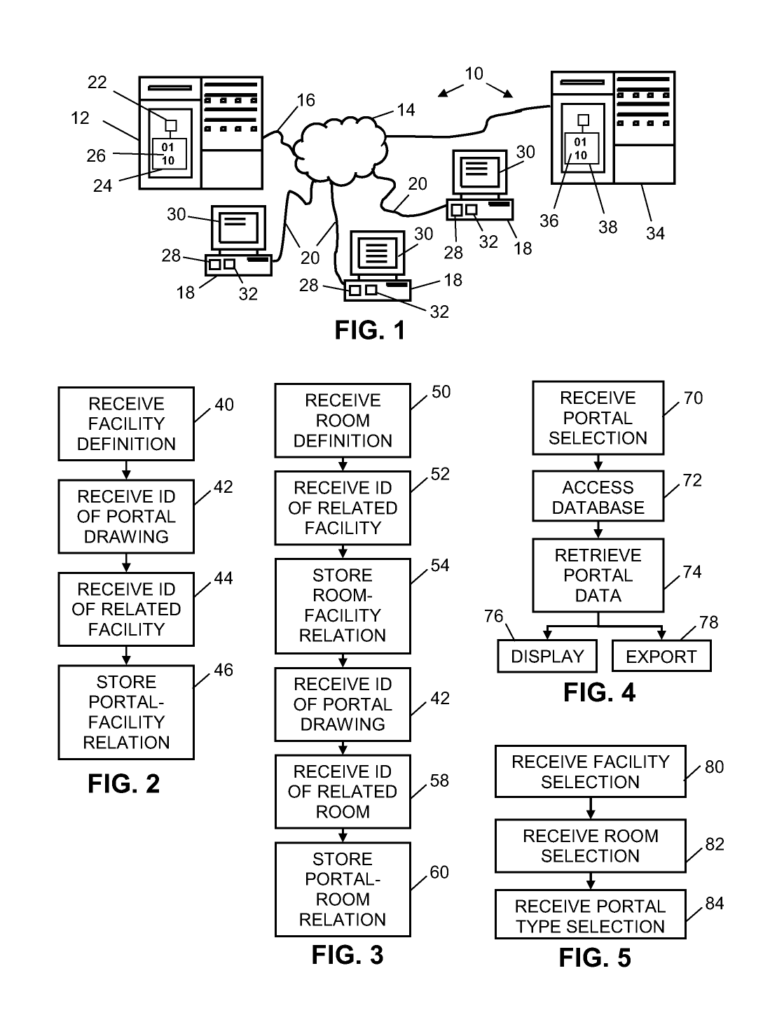

FIG. 1 illustrates a system for compiling as-built drawings, generally designated 10, according to an embodiment of the invention. The system 10 includes a server 12, a network 14, a data carrying communication link 16 connecting the server 12 to the network, and one or more terminals 18 (input devices) connected to the network 14 such as by wired connections 20. The server 12 also includes a processor 22 in which is associated with a computer-readable medium 24 in which a series of computer-readable statements and instructions 26 are stored in the form of a program for controlling operation of the processor 22. The network 14 may be the internet, a telecommunications network, or a combination of the internet and a telecommunications network. Users of the system 10 provide input to the network 14 via use of the one or more terminals 18 such as a personal computer, a desktop computer, a laptop computer, a mobile phone, a smart phone, a telephone, a wireless email device, a cable/satellite box, a television, a notebook, a tablet computer or any other device with sufficient memory, processing power and connectivity to be able to communicate with the server 12. The one or more terminals 18 are used by one or more building managers, owners or other users in conjunction with the processor 22, operated as per instructions 26, to compile and access as-built records for their buildings. At the same time, one or more other terminals 18 may be used by other building managers. The terminals 18 may be remote from the server 12 and may provide input of information to and display output from the processor 22 via the network 14. Thus, the output is produced by the processor 22 within the server 12 which acts on the computer-readable instructions 26 and the inputs and information provided by the users. The output is transmitted via wireless or wired connections 16, 20 to terminals 18, in which other processors 28 cause the display of the output on screens 30 of the terminal. Terminals 18 may also include memories 32 carrying other computer-readable instructions for receiving the output from the server 12 and converting it into a format suitable for display, and for accepting inputs from users and transmitting them to the server.

A database may be provided in the server 12, such as in the computer readable medium 24. The database may contain information relating to users and as-built sets of drawings, the information being accessible by execution of the program instructions 26 by the processor 22. Such a database may be optionally provided in a further server 34, which may include computer-readable information 36 on a computer-readable medium 38. A plurality of such databases may be provided for different types of data storage, or the different types of data may be stored in different tables within the same database. Different users of the system may use different servers and different terminals.

The program is written using known in the art methodology in one or more common computer programming languages known in the art such as C++, PHP, MySQL, HTML, AJAX, Java, SQL, Javascript, SSE, ASP or any other known computer programming language or any version or variation of these and the output can be presented to the user in the format of web pages, a print, a file, an email or any other known form for presenting information.

FIG. 2 relates to a basic method carried out by the processor 22 of the system 10, executing the programmed instructions 26, in accordance with an embodiment of the invention. The processor 22 is configured in step 40 to receive a definition of a facility via a terminal 18, for example via a form in a web page displayed in a browser program. The processor 22 may simply accept a facility name in order to define a facility. Further information may be received to describe the facility in more detail, such as a brief description, a detailed description, a facility number, notes and/or images. The processor 22 is configured in step 42 to receive an identification of a portal drawing. The user may be prompted to enter a portal name via another form displayed on the terminal 18. The user of the system 10 may already have available an existing portal drawing, in which case it is selected and uploaded by the processor 22, for example using a file browse button incorporated in the form. If there is no existing drawing, a user with no drawing skills may create one by selecting choices presented by the system 10 as pull-down options in the form. Whether the portal drawing pre-exists or it is created by the processor 22, an identification of it is provided to the system 10. Such an identification may be a portal name, number or both. In step 44, the user on the terminal 18 enters an identification of the facility in which the portal is located, or to which it is associated. When the processor 22 has received this identification, in step 46 it stores a relation, or link, between the facility and the portal. This can be repeated for numerous portals and numerous facilities. The result may be one or more database tables defining the relations between facilities and portals. As can be appreciated, there are many other ways in which this and other features of the invention may be realized.

FIG. 3 shows a method with further steps carried out by the processor 22 of the system 10 in accordance with an embodiment of the present invention. Since facilities usually contain more than one room, the processor 22 may be configured to allow the users to define rooms and associate the portals to the rooms. In step 50, the processor 22 is configured to receive a definition of a room, again via terminal 18, for example via a form in a web page displayed in a browser program. The processor 22 may simply receive a room name in order to define a facility. Further information may be received to describe the room in more detail, such as a brief description, a detailed description, a room number, notes and/or images. In step 52, the user via terminal 18 enters and the processor 22 receives an identification of the facility in which the room is located. After receiving this identification, the processor 22 in step 54 stores a relation between the room and the facility. The processor 22 may then in step 42 receive an identification of a portal drawing, as described in relation to FIG. 2. In step 58, via the terminal 18 the user enters, or selects via a pull-down option menu for example, an identification of the room in which the portal is located. When the processor 22 has received this identification, in step 60 it stores a relation between the room and the portal. This can be repeated for numerous portals and rooms. The result may be one or more database tables defining the relations between portals, rooms and facilities.

FIG. 4 shows a flowchart of a process for retrieving data pertaining to the portals. In step 70, the processor 22 of the system 10 receives, via a terminal 18 for example, a selection of the portal or portals in which a user is interested. Upon receiving the selection, in step 72 the processor 22 accesses its database and, in step 74, retrieves the information pertaining to the selected portals. The processor 22, as per step 76, is configured to display the portal information and drawings and/or, as per step 78, to export it, depending on the user's choice received.

FIG. 5 shows more detail of the steps the processor 22 of the system 10 may perform when receiving a portal selection. Portals may be searched for or selected by name, number and/or by any other filter that may be applied. For example, they may be selected when the processor 22, in step 80, receives a selection of a facility or facilities in which they are located, followed optionally, in step 82, by receiving a selection of the room or rooms in which they are located, and optionally, in step 84, by receiving a selection of the portal type. Portals may be also selected by type, installation date, manufacturer, part number, scheduled maintenance date, repair status, etc. depending on the amount of information provided to the system.

As a result, information relating to all the portals in a facility and how they relate to that facility may be stored in a central location that is easily accessible via use of one of the terminals 18 and the processor 22 of the system 10.

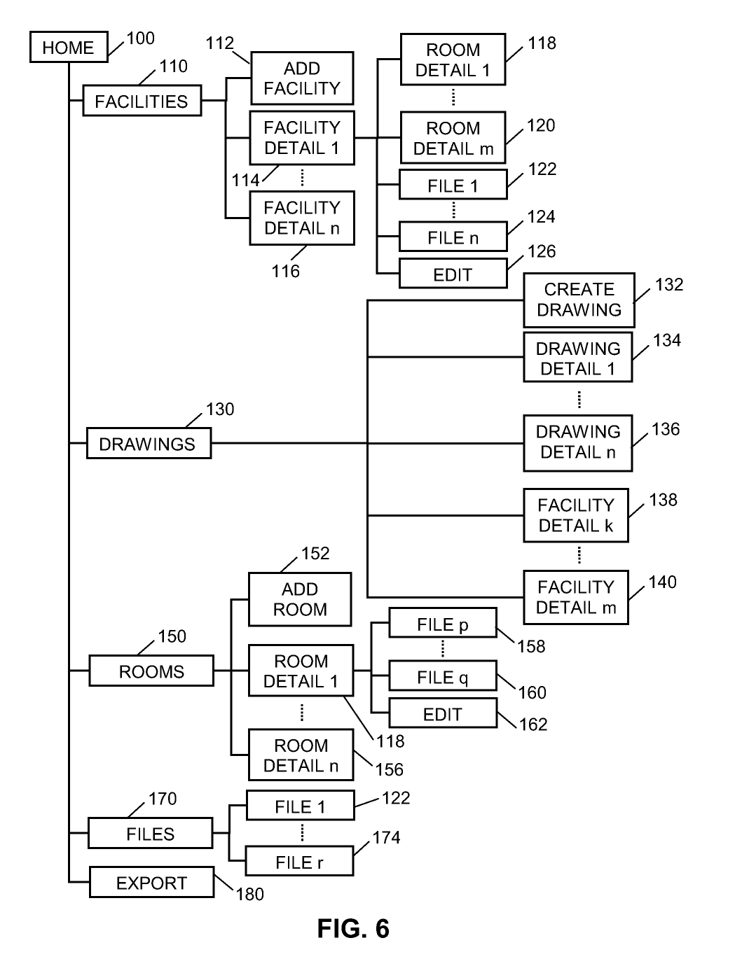

FIG. 6 shows an example sitemap of an embodiment of the invention. Displayed on the home page 100 are links to main pages as follows: facilities page 110, drawings page 130, rooms page 150, files page 170 and export page 180.

On the facilities page 110 a further link is displayed which takes a user to a page 112 for adding or defining a facility. Also displayed on the facilities page 110 is a list of existing facilities stored in the system 10, such as facilities 1 to n. Each existing facility listed has a link to the detail pages 114, 116 of the corresponding facility. For example, the Facility 1 detail page 114 lists the rooms that are located in Facility 1 and the files that are associated with Facility 1, and likewise for other facilities. Each listed room may have a link to the corresponding room detail page 118, 120, and each listed file may have a link to a file page 122, 124 that opens the file. Also displayed is a link for taking the user to a page 126 for editing the details of the facility.

On the drawings page 130 a link is displayed which takes the user to a page 132 for creating or uploading a new portal drawing. The drawings page 130 also displays a list of the existing drawings, with links that take the user to detail pages 134, 136 for such drawings. For each listed drawing there is also a link displayed that will take the user to a facility detail page 138, 140 to which the drawing corresponds. In an alternate embodiment, for example, links may also be shown to the room pages to which the drawings may correspond. Table 1 shows an example of a list of drawings that may be displayed on drawings page 130. Each row relating to a portal drawing may include links to the template used for the drawing, the notes and a preview. The template shows the options that were selected from the pull-down menus when the drawing was created. The notes, if any, are those added by the user and the preview link will display the drawing. A search function may be applied to the table in order to show a filtered selection of the portal drawings.

TABLE 1

| | | | | | Portal | Technology | |
|---|---|---|---|---|---|---|---|
| Template | Notes | Preview | Facility | Portal Name | Number | Type | Room |
| link | link | link | 123 | Front | A1 | Freedom | Main |
| link | link | link | 123 | Rear | A2 | Freedom | Main |
| link | link | link | 239 | Entry | B33 | Control Panel | Office |
| | | | | | | Remote | |
| | | | | | | Freedom | |
| link | link | link | 239 | Exit | B34 | No System | Office |
| link | link | link | 239 | Side door | C35 | No System | Labs |

On the rooms page 150 a link is displayed that takes the user to a page 152 for adding a new room. Also displayed is a list of existing rooms. With each listed room there is a link to the room detail page 118, 156 for the corresponding room. If a user goes to the detail page 118 for Room 1, for example, a list of the files associated with that room is displayed, with links that take the user to file pages 158, 160 displaying the files. Also, on the Room 1 detail page 118 there is a link that takes the user to an edit page 162 for that room. The same applies to other room detail pages. A portion of the list may be displayed as a result of filtering the data associated with the rooms.

On the files page 170, a list of all the facility files uploaded or created in the system 10 is displayed. As is common, the list may be displayed in portions or in full depending on the number of files, the preference of the user, the size of the screen or the choices made when programming the system 10. With each listing there is a link that takes the user to a file page 172, 174 that displays the listed file. Files that may be uploaded include architectural plans, annotated architectural plans representing as-built conditions, plumbing diagrams, electrical wiring diagrams, lighting fixture locations, ethernet cabling, HVAC, details of contractors, invoices, bills of material, original bid specifications, room functions, room occupants, scanned files, electronically created files, photographs, etc. Types of files that may be uploaded include DWG, JPG, TXT, DOC, GIF, TIFF, PDF, etc.

Also linking from the home page 100 is an export page 180 that allows the user to download some or all of the files, drawings, thumbnails, notes and other information relating to a room, a facility or a selection of portals. A parts list for the components in the portals may be included or downloaded separately from the files with the drawings. Previews of the data may be shown to the user before export. Export may be achieved, for example, by zipping the files and data etc. and then transmitting the zipped file via the Internet to the user's terminal. The user may then store the exported data locally or make copies as needed. Information exported may be used in a contingency situation, such as an emergency. Data downloaded may include floor plans, locations of portals, details of portal types, wiring, other documents, etc.

There may of course be further links to other pages, such as a page detailing the drawing legend used. Many different configurations of the sitemap may be employed to achieve an equivalent effect, and it is not necessary to include all the site pages shown in the site map.

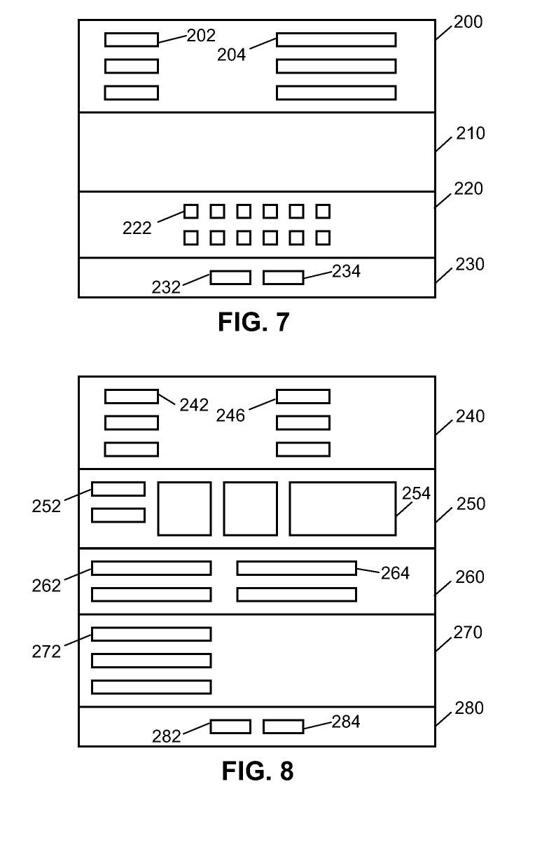

FIG. 7 shows a schematic diagram of a screenshot for defining a facility, as discussed in step 40 of FIG. 2 and web page 112 of FIG. 6. The screen displayed has a heading zone 200 for allowing the user to enter an identification and description of the facility. For example, there are labels 202 that are displayed alongside entry boxes 204 for the user to enter text and/or numbers. For example, the labels 202 could be Facility Name, Short Description and Long Description. Other descriptors may also be used. Another, notes zone 210 is displayed, comprising a field into which a user may optionally type and/or drag images. Toolbar 220 comprises editing buttons 222 that allow the user to format the notes that are entered. The zone 230 comprises a save button 232 and a cancel button 234.

FIG. 8 is a schematic diagram of a screenshot that depicts the detail of a facility, and may, for example, correspond to web page 114 of FIG. 6. Heading zone 240 displays the names 242 of the heading labels, such as Facility Name, Short Description, Long Description, Number of Images, Time and Date Created, some of which may be included in headings 202 of FIG. 7. Alongside the heading sections are the values or entries 246 of the heading sections as entered by the user or automatically determined by the system. Notes zone 250 shows the notes 252 and images 254 added by the user. Rooms zone 260 displays room names 262 and room descriptions 264 that are associated with the facility. Files zone 270 lists the files 272 that are associated with the facility. List entries such as room names 262 and file names 272 may actually be hyperlinks to the room detail pages or file display pages respectively. Zone 280 comprises an edit button 282 and a back button 284.

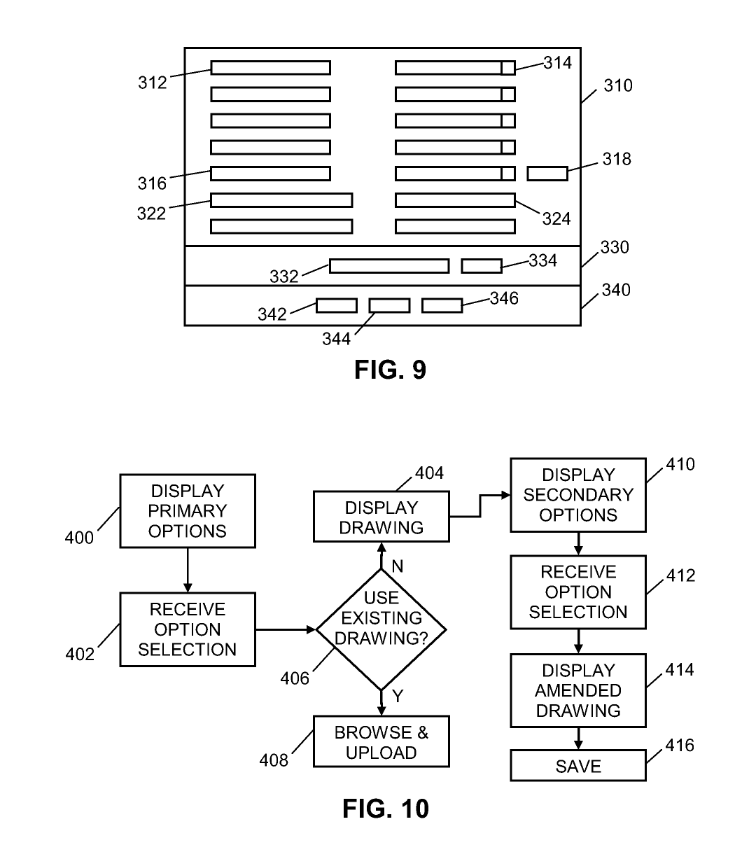

FIG. 9 is a schematic diagram of a screenshot for creating or identifying a portal drawing. Template or summary zone 310 displays option headings 312 and pull-down choices 314 containing options that may be selected by the user. For example, the option headings may be Technology Type, Portal Type, Power Over Ethernet, Facility, Room etc. For Technology Type, the user may, for example, be provided with a choice that includes different access control technologies as follows: (1) Control panel (legacy) based access control systems; (2) Freedom™ Access Control System by Viscount Systems Inc., needing no control panels and is IP centric; and (3) No electronic access control system, i.e. mechanical components only. Wiring diagrams may automatically be created based on this selection. For Portal Type, options may, for example, be barrier gate, swing gate, garage door, single door right swing, single door left swing and double door. The Power Over Ethernet (POE) choice may be POE Reader, POE Lock or No POE. If a room needs to be specified for the drawing, and it has not yet been created, then a link 318 may be displayed that will switch to a page that will permit the user to create a room. Other headings 322 may not require a pull-down menu of options, and may simply require the input by the user of a name for the portal, and/or a number in an input field 324. The upload zone 330 displays an entry box 332 that permits the user to enter a filename of an existing portal drawing that can be uploaded. Such a file may be selected using a browse button 334. The lower zone 340 includes a save button 342, a back button 344 and an Add Facility button 346. When the save button 342 is clicked, the portal drawing is associated with the room and/or facility specified by the user and, if an existing portal drawing has not been entered, a portal drawing is automatically created based on the options selected by the user from the pull-down menus.

FIG. 10 is an example flowchart that is followed by the processor 22 of the system 10 when creating a portal drawing, as a result of a user entering information into the fields displayed in FIG. 9 and clicking the save button 342. In alternate embodiments, steps may be performed in a different order to that shown. In step 400, the processor 22 causes display of the primary options using the pull-down menus as described in relation to FIG. 9. The processor 22 then receives and accepts, in step 402, the choices made by the user. In step 406, the processor 22 offers the user a choice of entering an existing filename, and if so, the file is uploaded in step 408. If not, the processor 22 automatically creates and displays in step 404 a drawing based on the user's selections. On the same screen as the drawing, a zone containing secondary options is displayed in step 410. For example, a secondary option heading may be, “1^{st} Electronic Exit Reader”, and the choice presented to the user may be mullion reader, Wiegand reader, single gang reader or none. As another example, a further secondary option heading may be, “Electronic Entry Means”, offering the choice of Wiegand mullion, Wiegand mini reader, Wiegand keypad and reader, Wiegand long range reader, mullion reader, single gang reader and none. As each secondary option is selected in step 412, or unselected or changed, the automatically created drawing is updated in step 414 to show or hide the corresponding secondary feature and any wiring that may be associated with it. In Table 2, further examples of secondary options are shown, of which some or all may be employed. Others not included may be used as well, or instead. When a user is satisfied with the options selected, the portal drawing may be saved in step 416.

TABLE 2

| Secondary Option | Options |
|---|---|
| Alarm state | Alarmed, none |
| Fire status | Fire exit, none |
| Relay security | Reader relay, remote relay, none |
| 1^{st} electronic exit | floor mat, Wiegand mini reader, Wiegand |
| | mullion, motion sensor, electronic panic bar, |
| | push button, electronic and manual panic bar, |
| | Wiegand single gang, mullion reader, Wiegand |
| | keypad, single gang reader, Wiegand long |
| | range reader, none |
| 1^{st} mechanical exit | push plate, thumb latch, handle, panic bar hard, |
| | door knob, none |
| Lock type | fail safe strike, fail secure strike, upper mortise, |
| | floor mortise, shear magnetic lock, none |
| Emergency exit pull | pull station, none |
| Cable feed | Flexible conduit, coiled cable door feed, electric |
| | hinge, none |
| Panel type | touch, touch keypad, pedestal, none |
| Electronic hold open | hold open, none |
| Door pinning | upper pin, floor pin, dual pins, dead bolt, none |
| Door open mechanism | door knob, handle, none |
| Public override | key switch. none |
| 2^{nd} electronic exit | floor mat, Wiegand mini reader, Wiegand |
| | mullion, motion sensor, electronic panic bar, |
| | push button, electronic and manual panic bar, |
| | Wiegand single gang, mullion reader, Wiegand |
| | keypad, single gang reader, Wiegand long |
| | range reader, none |
| 2^{nd} mechanical exit | push plate, thumb latch, handle, panic bar hard, |
| | door knob, none |

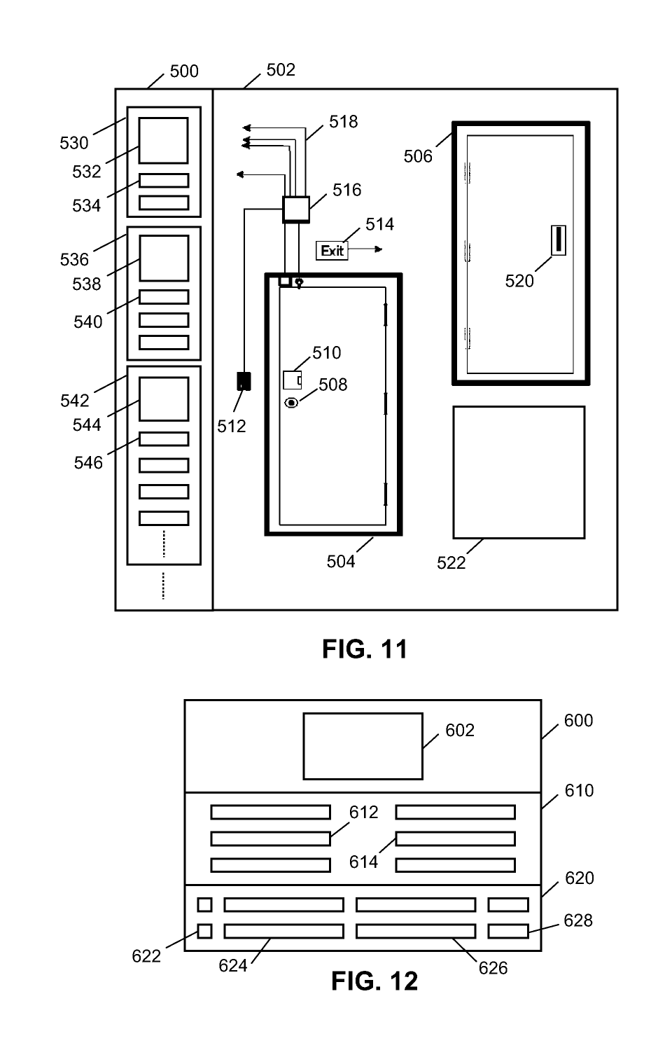

FIG. 11 is a schematic diagram of a screenshot of an automatically created portal drawing, with related notes and secondary options. In screenshot panel 500 the system displays zones 530, 536 and 542 which each relate to a secondary option. For example, in zone 530 a note 532 is displayed relating to a secondary option. The user may write or edit the note 532 in this view. Also displayed in zone 530 are the available choices 534 for the secondary option, which may be changed by the user. Likewise, zone 536 contains notes 538 and selectable options 540. Similarly, zone 542 contains notes 544 and selectable options 546. Notes may include models, serial numbers and warranty information, for example. Screenshot panel 502 depict the automatically created portal drawing. There is an exit view 504 and a front view 506. Depending on the type of portal, other views may be included. For example, for barrier portals, a top view showing the in-ground wiring loops may be included (e.g. arm loop, close loop, exit loop). View 504 shows secondary option features that have been selected by the user, such as a door knob 508, push plate 510, Wiegand reader 512, exit sign 514, panel 516, wiring 518 and, on view 506, handle 520. These features may be automatically toggled on and off as and when the user changes the selection of secondary options 534, 540, 546. Also shown in panel 502 are one or more automatically created notes zones 522 that refer to the selected primary and/or secondary features of the portal. These notes may include installation tips, recommended cable gauges, etc.

Portal drawings may be created before actual installation as a guideline to the installer. Such drawings may include generic definitions of the components to be used, the actual choice being determined by the installer or the building manager. During installation the installer may access the system to enter notes, dimensions, part numbers, serial numbers or to amend the portal drawings if necessary. An administrator of the system may grant the installer the necessary access to make such changes. In a more sophisticated embodiment, the components of the standard portals drawings may be selected and dragged to different positions on the screen in order to correspond to the desired location or actual installed location. Also, the sizes of the components may be changed.

In other cases, the portal drawings may be created after installation, from sketches and notes made by the installer.

FIG. 12 is a schematic diagram of a screenshot showing a summary of a portal drawing. Zone 600 includes a thumbnail image 602 of the portal drawing that may be clicked. Zone 610 includes summary information, with headings 612 such as portal name, portal number, type of drawing, date and time created, completeness. The values 614 of those headings may be shown alongside them. Zone 620 lists the files related to the portal. For each file 624 listed, there may be a delete button 622, a time/date field 626 and a size 628.

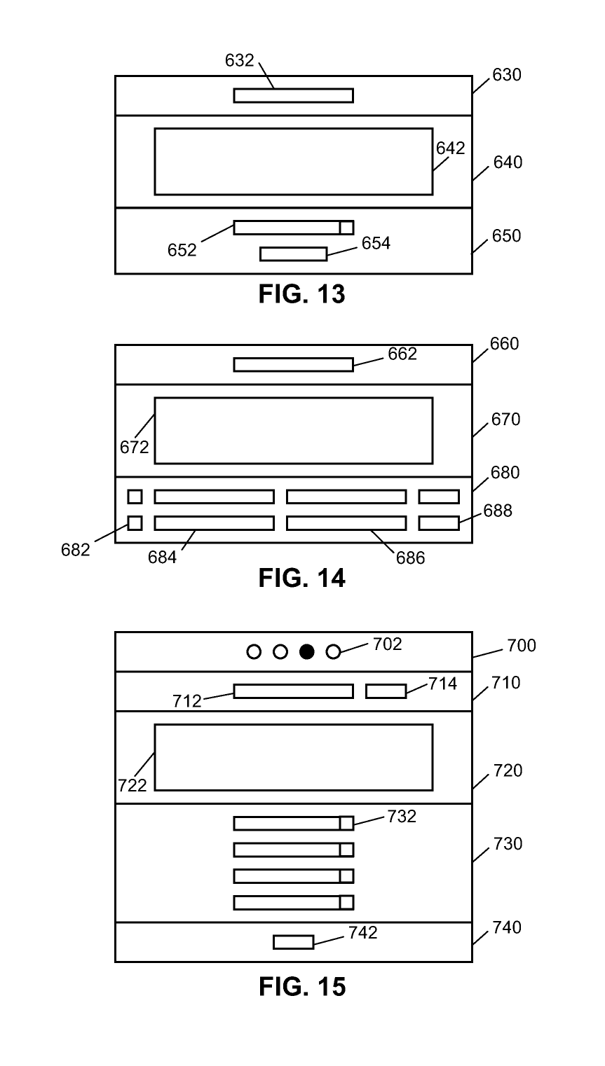

FIG. 13 is a schematic diagram of a screenshot for defining a room. Zone 630 includes a box 632 for entering the name of the room. Zone 640 contains a field 642 for entering a note about the room. Zone 650 includes a pull-down option box 652 for selecting the facility in which the room is located. Link 654 allows a user to create a new facility if one needs to be defined.

FIG. 14 is a schematic diagram of a screenshot showing detail of a room. Title zone 660 contains the title 662 of the room. Notes zone 670 contains the notes 672 relating to the room. Zone 680 contains a list of files related to the room, including in each row, for example, a delete button 682, a file name 684, a date and time created 686 and a size 688.

FIG. 15 is a schematic diagram of a screenshot for adding a file. Zone 700 includes a set of radio buttons 702 from which the user selects one to specify whether to associate the file to a portal drawing, a facility, a room or a part number. Other objects to which an association may be made can be included depending on the embodiment chosen. Zone 710 includes a box 712 for entering a filename and a browse button 714 for finding a file to upload. Notes zone 720 includes notes 722 that can be added about the file. Zone 730 includes the same number of pull-down options 732 as there are radio buttons. Only the pull-down menu relating to the selected radio button can be accessed. If the portal drawing radio button is selected, the pull-down menu gives the user a choice of existing portal drawings. Other pull down options give the user a choice of existing facilities, existing rooms or existing part numbers. Zone 740 contains an upload button 742, which, when clicked, causes the system to upload the selected file to the server and store a relation in one of its databases linking the file to the relevant portal, facility, room or part number. Files are stored without significant amendment to the content therein.

### Automated Bill of Material Generation

As part of the definition of a portal, each component of the portal may be specified by its part number and stored in a database. For example, a portal may have a reader that is specified by its part number and manufacturer. Likewise, it may have a magnetic lock that is in turn specified by its part number and manufacturer. The same applies to the other components necessary for the portal. At the time of an upgrade, by selecting the portals that need to be upgraded, the data pertaining to the components of the selected portals may be selected and automatically aggregated to form a bill of materials containing part numbers, manufacturers and quantities required. Details (e.g. parts numbers, manufacturer names) of equivalent components may be stored in the system and the user may be able to select different manufacturers, so that the system generates alternate bills of materials. Broken or malfunctioning components or portals may be flagged in the database, and such components or portals may be searched for in order to create a bill of materials for their replacement.

### Variations

In addition to the types of information specified above, which may be included with a compiled set of as-built set of drawings, further types of information may additionally be included. This may include, for example, information about elevators, escalators, security devices, alarms, any other installed devices, gates, electrical wiring, fiber optic cabling, network cabling, door material, material around the door, window locations, cameras, camera coverage area, camera alignment, live video, records of live video, installed dates, etc. Photographs may be included in the files uploaded. Photographs that include superimposed drawings generated by users may also be included. Video clips may be included of rooms within the facilities, or corridors, and may be taken with a 180° camera, for example. Video clips of the operation of portals may be included. Video clips may be linked or related to a floor plan of the building, as may be the rooms and portal drawings. Audio clips may also be added. Many variations of the sitemap may be made.

Users of the system may purchase the system as a stand alone system, to which only they alone have access. Alternately, users may purchase a subscription to it as software as a solution. Other methods of charging for it may be on a per-download basis, per-access period, per number of items stored, per amount of memory used, etc. Manufacturers that are listed in the portal definitions and that are named on automatically generated bills of material may pay the owner or operator of the system a fee or a commission depending on the number or value of units sold. The system may be configured to transmit the bill of materials directly to the manufacturer in the form of a purchase order.

### INDUSTRIAL APPLICABILITY

A particular benefit of the system and method disclosed herein is that portals, drawings and any other installed devices can be grouped by room so that access to and manipulation of data is facilitated. The system may be used as a tool by building managers who need to maintain, modify or change the buildings for which they are responsible. It may be used for school districts or government departments that need to manage large numbers of buildings. It may be used by consultants who are charged with upgrades to security systems, it may be used to provide parts lists to bidders or it may be used by auditors. It may be used as a remote vault and a source of detailed information to be provided to emergency services at short notice. Emergency situations that may be helped by rapid access to building information include fires, floods, earthquakes, bombs or bomb threats, hostage taking, etc. These are only a few examples of the ways in which the method and system may be used, and many more embodiments are possible.

As will be apparent to those skilled in the art in the light of the foregoing disclosure, many alterations and modifications are possible in the practice of this invention without departing from the scope thereof. Accordingly, the scope of the invention is to be construed in accordance with the substance defined by the claims below.

1. A system for compiling as-built drawings, comprising:
a terminal; and
a processor connected to the terminal, the processor configured to:
receive via the terminal a definition of at least one facility;
receive via the terminal, for each facility, at least one facility file relating to a drawing thereof;
receive via the terminal a definition of a portal that is installed in one of said facilities,
receive via the terminal an identification of the facility to which the portal relates;
store the at least one facility file;
store a drawing of the portal; and
store a relation between the portal and the facility to which the portal relates.

2. A system according to claim 1 wherein:
the definition of the portal comprises one or more selections from pre-defined options; and
the drawing of the portal is automatically created by the processor based on the selections.

3. A system according to claim 2, wherein the processor is also configured to accept via the terminal user amendments of the drawing.

4. A system according to claim 1, wherein the facility file is stored without significant amendment.

5. A system according to claim 1 wherein the drawing of the portal is stored in a file that is different from the facility files.

6. A processor-implemented method for compiling as-built drawings, the method comprising:
receiving at a processor via input from a terminal a definition of at least one facility;
receiving at the processor via input from the terminal, for each facility, at least one facility file relating to a drawing thereof;
receiving at the processor via input from the terminal a definition of a portal,
receiving at the processor via input from the terminal an identification of the facility to which the portal relates;
storing by the processor in a database the at least one facility file;
storing by the processor in a database a drawing of the portal; and
storing by the processor in a database a relation between the portal and the identification of the facility to which the portal relates.

7. A method according to claim 6, wherein the drawing of the portal is in a file that is specified in the definition of the portal.

8. A method according to claim 6, wherein the drawing of the portal is automatically created by the processor based on the definition of the portal.

9. A method according to claim 8, wherein the definition of the portal comprises one or more selections from pre-defined options.

10. A method according to claim 9, further comprising:
amending the drawing based on one or more inputs received from a user.

11. A method according to claim 6, wherein the facility file is stored without significant amendment.

12. A method according to claim 6, wherein the portal is currently installed in the facility to which the portal relates.

13. A processor-implemented method for compiling as-built drawings, the method comprising:
receiving at a processor via input from a terminal a definition of at least one facility;
receiving at the processor via input from the terminal, for each facility, at least one facility file relating to a drawing thereof;
receiving at the processor via input from the terminal a definition of at least one room;
receiving at the processor via input from the terminal, for each room, an identification of the facility in which the room is located;
storing by the processor in a database, for each room, a relation between the room and the facility in which the room is located;
receiving at the processor via input from the terminal a definition of a portal,
receiving at the processor via input from the terminal an identification of the room to which the portal relates;
storing by the processor in the database the at least one facility file;
storing by the processor in the database a drawing of the portal; and
storing by the processor in the database a relation between the portal and the room to which the portal relates.

14. A method according to claim 13, wherein a facility file includes a drawing of a room in the corresponding facility.

15. A method according to claim 13, wherein the drawing of the portal is in a file that is specified in the definition of the portal.

16. A method according to claim 13, wherein:
the definition of the portal comprises one or more selections from pre-defined options; and
the drawing of the portal is automatically created by the processor based on the selections.

17. A method according to claim 16, further comprising:
amending the drawing by the processor based on one or more inputs received from a user via the terminal.

18. A method according to claim 13, wherein the facility file is stored without significant amendment.

19. A method according to claim 13, wherein the portal is currently installed in the room to which the portal relates.
